(19) United States
(12) Patent Application Publication
(10) Pub. No.: US 2015/0115652 A1
(43) Pub. Date: Apr. 30, 2015

(54) Trailer Fender with Storage

(71) Applicant: Robin Peng, Sandy, UT (US)

(72) Inventor: Robin Peng, Sandy, UT (US)

(21) Appl. No.: 14/530,523

(22) Filed: Oct. 31, 2014

Related U.S. Application Data
(60) Provisional application No. 61/898,367, filed on Oct. 31, 2013.

(51) Int. Cl. B62D 35/00; B60R 9/02; B62D 25/16

(52) U.S. Cl. CPC B62D 35/00; B62D 25/16; B60R 9/02
USPC 296/180.4

(57) ABSTRACT

A series of fender systems for vehicles is disclosed. Each embodiment utilizes a separate mounting assembly by which a fender assembly may be attached to a vehicle. The fender assemblies in each system reduce drag and buffeting caused by current fenders in the art.

### FIELD OF THE INVENTION

The present invention relates to the field of vehicles and more particularly relates to a fender attachable to a trailer or other vehicle, the fender having at least one storage compartment.

### BACKGROUND OF THE INVENTION

The basic nature of modern wheeled vehicles is not much changed from their ancient counterparts. A wheel is mounted upon an axle which is in turn mounted upon the vehicle. Larger vehicles have larger axles, often with two or more wheels mounted thereupon. The very nature of a rotating wheel, especially at the speeds of a modern highway, is dangerous. To address this danger, the fender was an early innovation. The fender is, essentially, a cover that positioned over the rotating wheel so as to help prevent many forms of undesired interaction with said wheel—most often either keeping debris or a passenger or cargo from falling into the wheel or preventing debris from the road from being picked up and thrown by the wheel into the passengers, cargo or passersby.

Unfortunately, the modern fender has not changed very much from its older counterparts, in particular when aftermarket fenders are examined. The fenders in the prior art tend to be utilitarian and focus on the issue of safety. Most aftermarket fenders are mounted by direct attachment on the side walls of the vehicle. The mounting of an aftermarket fender takes a good deal of precise locating of the fender on the vehicle body. Aerodynamically, the aftermarket fender does little to improve the vehicle. As it resides a little above the wheel, the frontal sectional area is not terribly affected by an added fender, but the fender itself does not address much of the aerodynamic disturbance caused by a wheel.

The present invention is an after-market fender to be installed on an existing trailer or similar vehicle. It may, of course, be modified so that the fender may be standard equipment for such a vehicle. The fender is easily installed on the vehicle by an installed interface system supported on the vehicle. Not only does the fender provide durable storage, it also improves aerodynamics of the vehicle, thereby increasing efficiency and safety of the vehicle by reducing drag.

The present invention represents a departure from the prior art in that the fender of the present invention allows for installation on any trailer or similar vehicle with an axle with minimal alteration of said vehicle while providing safe and stable storage of items desired to be stowed. The installed interface system mounts about the axle of the vehicle and allows for both easy and sable mounting of the fender.

### SUMMARY OF THE INVENTION

In view of the foregoing disadvantages inherent in the known types of fenders, this invention provides an aerodynamic fender with storage. As such, the present invention's general purpose is to provide a new and improved fender that is easy to solidly mount upon a trailer or other vehicle.

To accomplish these objectives, the fender comprises an aerodynamic shell, preferably made of aluminum, fiberglass or a composite material. The shell features a mounting interface. A corresponding vehicle located mounting interface, or “sub-assembly,” is positioned on the vehicle and features a mating interface system. Proper, one-time, positioning of the sub-assembly allows for quick and easy mounting of the fender in a centered and ideal position relative to the trailer. Five separate interfaces are disclosed.

The new fender presents a similar forward sectional area of the trailer as compared to current fender designs; but, the material is fashioned in an aerodynamically advantageous shape so as to improve aesthetics and, more importantly, reduce drag and turbulence caused by a fender. By reducing drag and turbulence, fuel efficiency and vehicle stability are increased. Also, turbulence interaction with other vehicles, known as “buffeting,” is reduced. Buffeting is created by large aerodynamic disturbances caused by the wheels of trailers and other vehicles. Buffeting is a hazardous aerodynamic condition, especially when smaller vehicles, such as motorcycles, as subjected to it.

Mounting the fender on the sub-assembly is easily facilitated by quick-detach fastening systems. These systems allow for easy removal and re-installation of the fender in cases where maintenance or cleaning are required. Each sub-assembly is also made to fragment in the event excessive sheer forces are placed on the fender, such as by a collision. In being so constructed, impacts to the fender are not translated through the entire sub-assembly to the trailer and less damage will happen to the trailer itself.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a composite image of the first embodiment of the fender system.

FIG. 1a is a perspective view of the brackets of the first embodiment installed on a vehicle.

FIG. 1b is a perspective view of two brackets for use with the first embodiment.

FIG. 1c is a rear perspective view of the fender assembly of the first embodiment.

FIG. 1d is a top plan view of the fender assembly of FIG. 1c.

FIG. 1e is a bottom perspective view of the Fender assembly of FIG. 1c.

FIG. 2 is a composite image of the second embodiment of the fender system.

FIG. 2a is a perspective view of the second embodiment of the fender system.

FIG. 2b is a perspective view of a shell structure utilized in the second embodiment.

FIG. 2c is a rear elevation of the shell of FIG. 2b.

FIG. 2d is an exploded view of the second embodiment shown in FIG. 2a.

FIG. 3 is a composite image of the third embodiment of the fender system.

FIG. 3a is a perspective view of the third embodiment of the fender system.

FIG. 3b is a side elevation of the third embodiment of FIG. 3a.

FIG. 3c is a perspective view of the brackets used in the third embodiment of the fender system.

FIG. 4 is a composite image of the fourth embodiment of the fender system.

FIG. 4a is a perspective view of the fourth embodiment of the fender system.

FIG. 4b is an alternate bracket for use in the fender system of FIG. 4.

FIG. 4c is a key system for use with the embodiment of FIG. 4.

FIG. 4d is an alternate key system for use with the embodiment of FIG. 4.

FIG. 5 is a composite image of the fifth embodiment of the fender system.

FIG. 5a is a perspective view of brackets for use with the fifth embodiment mounted upon a vehicle.

FIG. 5b is a perspective view showing the construction of the brackets of FIG. 5a.

FIG. 5c is a perspective view of the brackets of 5a, with rubberized cushions installed.

FIG. 5d is a perspective view depicting the brackets of FIG. 5a interfacing with a fender assembly.

### DETAILED DESCRIPTION OF THE PREFERRED EMBODIMENT

With reference now to the drawings, the preferred embodiment of the fender is herein described. It should be noted that the articles “a”, “an”, and “the”, as used in this specification, include plural referents unless the content clearly dictates otherwise.

With reference to Figures in general, the fender system comprises the compartmentalized fender and a mounting system attached to the vehicle. Five different embodiments are disclosed. Each embodiment has some common features. First, every embodiment has an isolation system, usually some form of rubberized cushion between the fender itself and the mounting system. These cushions isolate the fender from road shock and other jarring forces. Second, each fender has an adjustable height feature in order to accommodate different wheel sizes. The adjustable height is usually at least one block which is mountable between the fender and the mounting system. Each mounting system may be fitted with lighting for enhanced safety. The internal storage structure may be configured in any advantageous arrangement and may be constructed to accommodate specific items, such as extra fuel tanks, tools and cargo organizers. They may also be constructed to encapsulate their contents in the event of an accident. Each system features either tool-less or minimal tool mounting of the fender to the mounting sub-assembly in a quick and intuitive manner. Each fender body may be manufactured with collapsible body panels, similar to car fenders.

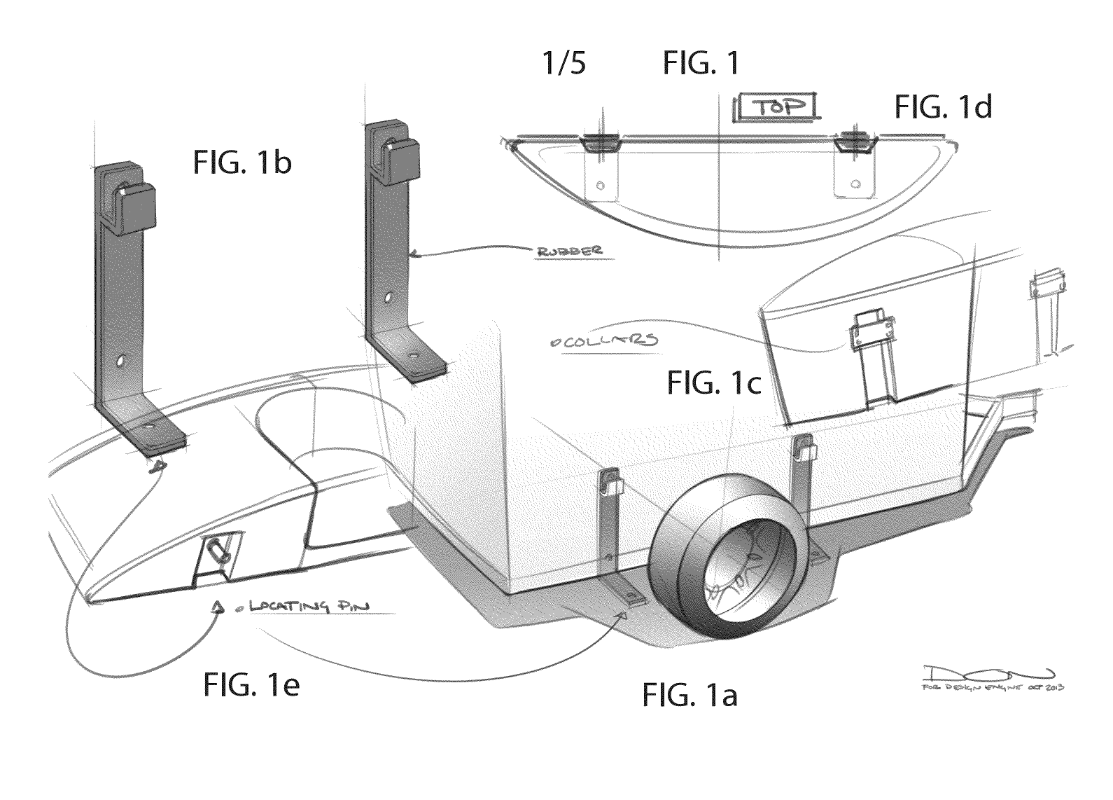

FIG. 1 depicts the first embodiment of the fender and mounting assembly. The mounting sub-assembly comprises two or more vertical L-brackets, as shown in FIGS. 1a and 1b. It is readily realized that the L-bracket may be replaced with a T-bracket, with the extra leg protruding under the vehicle and being attached thereto, for additional stability. For purposed of this Application, the term “L-bracket” shall be defined as including T-brackets or any other bracket which includes an L-shaped portion. The top of the each bracket is hooked upward. Rubberized isolation strips back each bracket and hook. The brackets are pre-mounted to the vehicle. Positioning the brackets is relatively easy and required simple mathematical calculation. The fender body features two rear collars and two lower divots directly underneath each bracket (FIGS. 1c and 1d). The brackets are slid behind the hooks while the divots rest on the lower bracket leg. A peg interface maybe provided for the divots and lower L legs, as shown in the FIG. 1e. The peg or locating pin is shown to be on the underside of the fender while a corresponding hole is shown on the lower bracket leg; however, this may be reversed or the peg may be replaced with a fastening bolt.

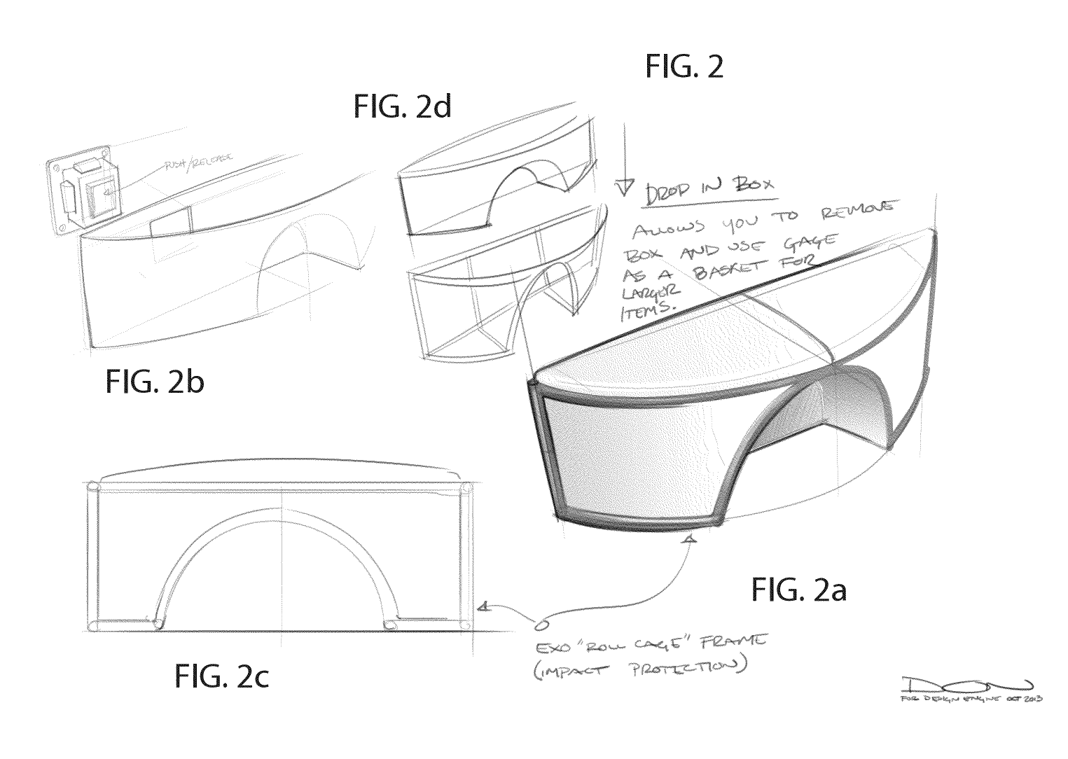

The second embodiment, shown in FIG. 2, is a three-part system. The first component is a plurality of at least one anchor mounted to the vehicle body, FIG, 2b. Like the brackets in the first embodiment, positioning is a matter of simple math. Each anchor features a push-button locking system where a central button is pushed and lateral teeth are drawn into the anchor body. An exterior shell is positioned over the anchors, with provided holes accommodating each anchor and the rims of said holes providing mating interfaces for the anchor teeth. The shell is shaped and sized to accommodate an inner drop-in box for storage (FIG. 2d). The shell features a cage substructure for durability and impact protection (FIGS. 2a and 2c). It should be noted that the shell and drop-in box concept may be adapted to any of the disclosed mounting embodiments.

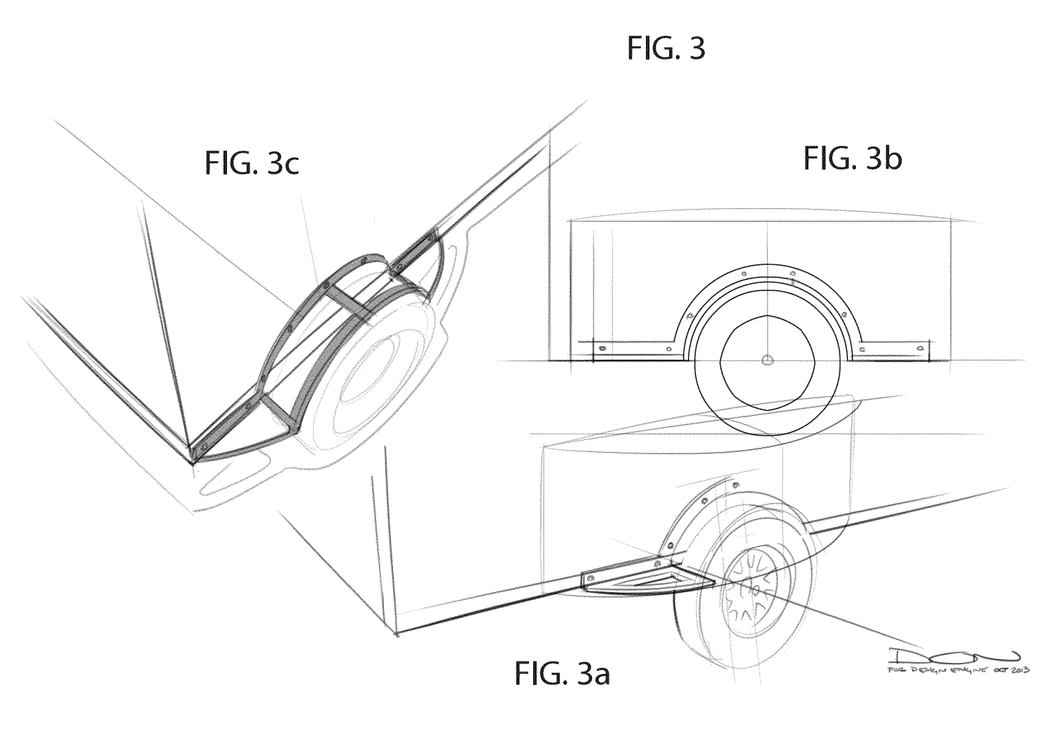

The third embodiment, shown in FIG. 3, features a mountable lower frame as a sub-assembly. The frame fits about the wheel well of the vehicle and features an arcuate fender support with lower support ledges (FIG. 3c). The fender body is then mounted upon the fender ledges and fender support (FIGS. 3a and 3b). It should be noted that an appropriate existing fender could be used as a fender support; or, the fender support could be positioned over or in place of an existing fender. The fender body is then fastened to the fender support through conventional means.

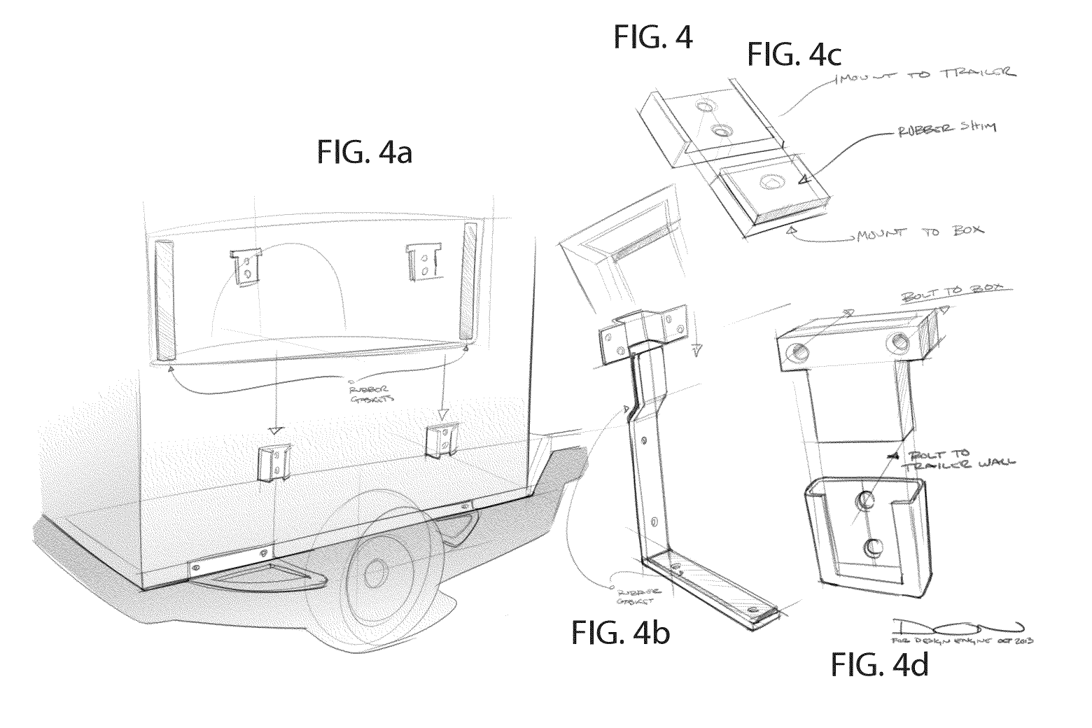

The fourth embodiment, shown in FIG. 4, is related to the third in that it utilizes a similar fender support. This embodiment, however, also utilizes one or more back interfaces (FIG. 4a). The depicted interfaces are male and female sliding blocks and frames keyed to fit one another. Any shape whereby the blocks may be keyed to each other, such as a dove-tail design, can be utilized (FIGS. 4c and 4d). One set of blocks or frames is positioned on the vehicle in a manner to interface with the mating set on the fender body (usually the frames being on the vehicle). A rubberized cushion may also be positioned between each block and its attached structure. An L-bracket may also be used in this embodiment (FIG. 4b).

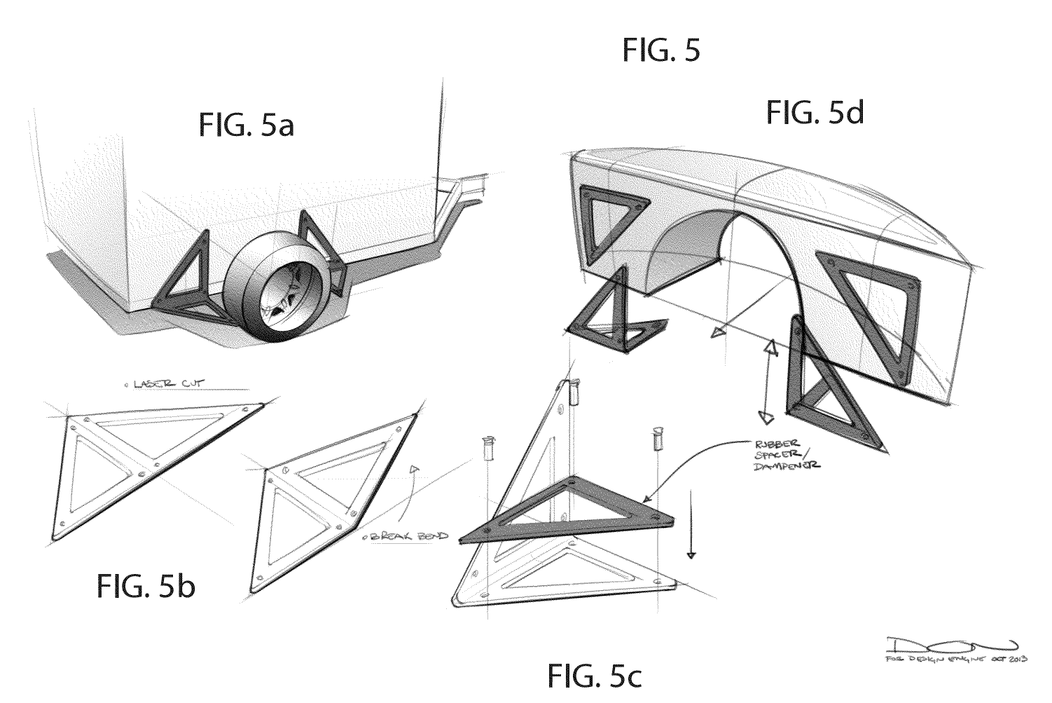

The fifth embodiment, shown in FIG. 5, utilizes two right angular brackets on either side of the wheel (FIG. 5a). The brackets are essentially two right triangles formed at right angles to each other (FIG. 5b). It should be readily appreciated that a third triangle or other structure may be utilized in a manner similar to a T-bracket. Once mounted, the brackets are positioned to interface with similar triangle structures on the back of the fender (FIG. 5d). As depicted, the vertical triangles face opposite directions, ideally hypotenuse outward. This arrangement automatically centers the fender on the brackets. The fender may then be fastened with bolts or other conventional means. As with other embodiments, a rubberized spacer is applied between the brackets and the fender for vibrational dampening (FIG. 5c).

One other potential feature of the invention is the positioning of the mounting means or brackets on a relatively stiff sheet of cardboard in such a manner as to pattern mounting on the vehicle. This pattern, then, may be positioned relative to the wheel in an advantageous manner without having to measure each bracket separately. This method reduces installer error and provides uniform mounting over all wheels.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A fender for a vehicle, the vehicle having a body, the fender comprising:
a. a plurality of brackets mounted to the body of the vehicle, each bracket further comprising:
i. an upper hook; and
ii. a lower leg extending outward from the vehicle;
b. a fender body, positionable over the plurality of brackets, the fender body further comprising a plurality of rear collars with which to interface with the brackets; and
c. rubber interfacing between the brackets and the fender body.

2. The fender of claim 1, further comprising at least one peg serving as a further interface between the fender body and the plurality of brackets.

3. A fender for a vehicle, the vehicle having a body, the fender comprising:
a. at least one anchor, mounted upon the vehicle, the at least one anchor further comprising a plurality of lateral teeth actuated by a button on the anchor surface;
b. a fender shell, mountable upon the at least one anchor; and
c. a storage module, insertable within the fender shell.

4. A fender for a vehicle, the vehicle having a body, the fender comprising:
a. at least one lower bracket, fastened about a wheel well of the vehicle; and
b. a fender body, mountable upon the bracket.

5. The fender of claim 4, further comprising compartments and mating key structures to interface the fender body with the vehicle body.

6. The fender of claim 5, further comprising at least one bracket, mountable to the vehicle, providing at least one of the compartments and key structures.

7. The fender of claim 5, the at least one bracket being two triangular brackets, mounted upon either side of the wheel well and the fender further comprising two triangular blocks mounted upon the fender body, the triangular blocks and brackets positioned to interface with each other and center the fender body over the wheel well.
